(19) United States
(12) Patent Application Publication
(10) Pub. No.: US 2012/0327019 A1
(43) Pub. Date: Dec. 27, 2012

(54) METHOD OF PRODUCING TOUCH SCREEN

(75) Inventor: Shigeyuki TAKAO, Fukuoka (JP)

(73) Assignee: PANASONIC CORPORATION, Osaka (JP)

(21) Appl. No.: 13/529,347

(22) Filed: Jun. 21, 2012

(30) Foreign Application Priority Data
Jun. 23, 2011 (JP) 2011-139437

(51) Int. Cl. B32B 38/10; G06F 3/044; B32B 37/00

(52) U.S. Cl. 345/174; 156/247; 156/324

(57) ABSTRACT

A method of producing a touch screen includes feeding and laminating a roll of an adhesive sheet material to bond a sheet glass, a roll of a first sheet material having first electrodes, and a roll of a second sheet material having second electrodes; pinching and pressing the laminated sheet materials between a pair of press rollers to form a laminated body of the bonded sheet materials. When being fed, the sheet materials are cut off at a predetermined length corresponding to a lateral size of a rectangular touch screen, and thus the sheet materials can be provided in a predetermined size in one cutting process. Rolling the sheet materials reduces wrinkles and folds and eliminates a protection sheet for each sheet material, which is required in a case of stacking a plurality of planar sheets, thus facilitating cost reduction.

### CROSS-REFERENCE TO RELATED APPLICATIONS

The present application claims priority under 35 U.S.C. §119 of Japanese Application No. 2011-139437 filed on Jun. 23, 2011, the disclosure of which is expressly incorporated by reference herein in its entirety.

### BACKGROUND OF THE INVENTION

1. Field of the Invention

The present invention relates to a method of producing a touch screen, particularly a method of producing a capacitance touch screen having linear electrodes intersecting one another.

2. Description of Related Art

A conventional touch screen has two sheet materials, each of which includes a plurality of linear electrodes parallel to one another. A first sheet material is bonded to a sheet glass and a second sheet material is bonded thereto such that the linear electrodes of the second sheet material intersect the linear electrodes of the first sheet material in a plan view.

Japanese Patent Laid-Open Publication No. 2009-064693A discloses a touch screen having a touch switch intermediate body for a capacitance touch switch produced by forming a base body portion in injection molding of a clear resin and bonding a clear conductive layer to a surface of the base body portion in in-mold forming to produce a clear conductive film.

In the touch screen disclosed in Japanese Patent Laid-Open Publication No. 2009-064693A, work hours can be reduced by using an in-mold film to bond the clear conductive film to the base body portion in in-mold forming. A process is required, however, to cut the in-mold film to fit the size of the base body portion for bonding of the clear conductive film, concurrently with forming of the base body portion in injection molding. In addition, positioning is required again to laminate two base body portions. Thus, work hours are increased and processes are complicated in a case of application to a touch screen having intersecting electrodes in a plan view.

Japanese Patent Laid-Open Publication No. 2010-262529A discloses a touch screen having a similar capacitance touch switch produced by screen printing or etching a metallic foil to form mesh electrodes on one surface of each of two substrates and by bonding and integrating the two substrates such that the mesh electrodes are provided opposite to each other through an adhesive layer.

In the touch screen disclosed in Japanese Patent Laid-Open Publication No. 2010-262529A, work hours can be reduced by forming the mesh electrodes by printing or etching. However, positioning is required to laminate the two substrates, complicating a process.

Japanese Patent Laid-Open Publication No. 2009-070191A discloses a touch screen having a capacitance sensor including very fine electrode groups, which is produced by bonding a pair of clear films each having a conductive film on one surface such that conductive films are provided outside and by etching the conductive films to form a plurality of electrode groups.

In the touch screen disclosed in Japanese Patent Laid-Open Publication No. 2009-070191A, however, etching after bonding the pair of clear films requires protection of one of the films while etching the other, thus increasing work hours and complicating a process.

### SUMMARY OF THE INVENTION

In view of the circumstances above, a main advantage of the present invention is to provide a method of producing a touch screen in reduced work hours and a simplified process.

An aspect of the present invention provides a method of producing a touch screen including a first sheet material having a plurality of linear first electrodes disposed in parallel to one another; a second sheet material having a plurality of linear second electrodes disposed in parallel to one another; and a laminated body provided by bonding the first sheet material onto the second sheet material such that the first electrodes and the second electrodes intersect with each other, the method including rolling the first sheet material and the second sheet material in directions in which the first electrodes and the second electrodes intersect with each other; providing an adhesive layer and a peel-off sheet covering the adhesive layer on at least one of the first sheet material and the second sheet material; feeding the rolled first sheet material and the rolled second sheet material; removing the peel-off sheet; and bonding the first sheet material and the second sheet material with the adhesive layer therebetween to form the laminated body.

According to the present invention, the width of the rolled sheet materials is provided so as to correspond to the longitudinal length of a rectangular touch screen, for example, and the sheet materials are cut at a predetermined length corresponding to the lateral size of the rectangular touch screen when fed out. Thus, the sheet materials in a predetermined size can be provided in one cutting process. Furthermore, rolling the sheet materials reduces wrinkles and folds compared to a case where sheet materials are stacked in flat piles. In addition, it is unnecessary to provide the rolled sheet materials with a protection sheet for each sheet material, which is required in a case of stacking a plurality of planar sheets to feed one by one, thus facilitating cost reduction.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 schematically illustrates a production overview of a touch screen according to an embodiment of the present invention;

FIGS. 2A to 2C are each cross-sectional views of a main portion illustrating a sheet material for adhesion, a first sheet material, and a second sheet material, respectively;

FIGS. 3A and 3B are each plan views illustrating the first sheet material and the second sheet material, respectively;

FIGS. 4A and 4B are each partial cross-sectional views illustrating a state in which the sheet materials are laminated and bonded and a state in which a second electrode lead is exposed, respectively;

FIG. 5 is a plan view illustrating an enlarged portion of the touch screen; and

FIG. 6 is a view illustrating a second embodiment in a similar manner to FIG. 5.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The embodiments of the present invention are described in detail below with reference to the drawings.

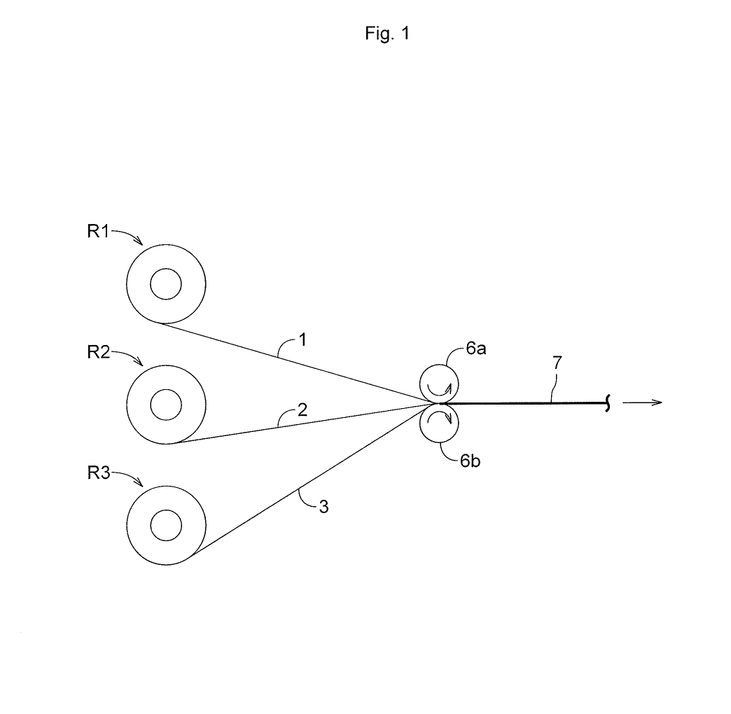

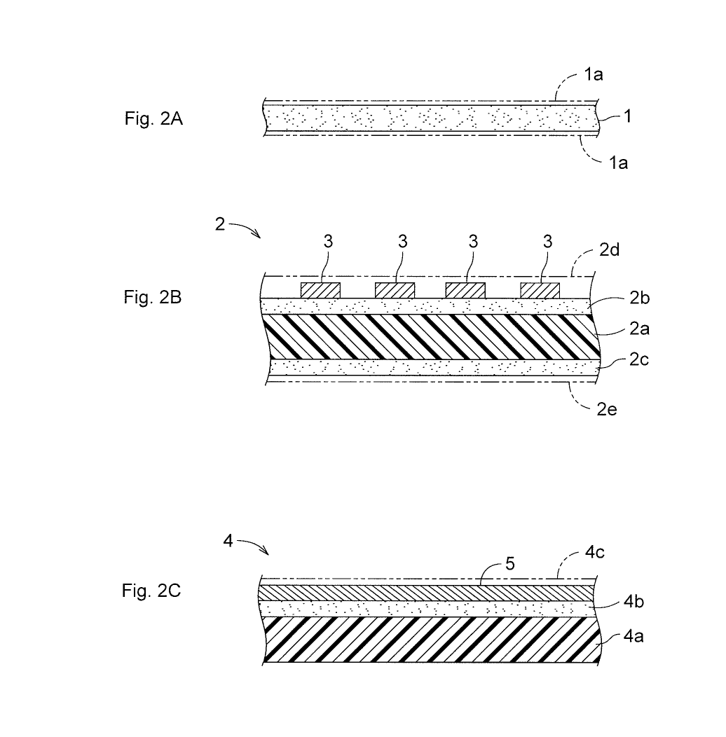

FIG. 1 schematically illustrates a production overview of a touch screen according to the embodiment of the present invention. Three rolls R1, R2, and R3 are prepared as materials of a touch screen as shown in FIG. 1. The upper roll R1 in the drawing is a rolled adhesive sheet material 1 for bonding a sheet glass described herein after. With reference to FIG. 2A, front and rear surfaces of the adhesive sheet material 1 are each covered by a sheet separator 1a to prevent the rolled adhesive sheet material 1 from adhering in an overlapping portion.

The middle roll R2 in FIG. 1 is a rolled first sheet material 2. With reference to FIG. 2B, the first sheet material 2 has, in a laminated state, a sheet base material 2a composed of a flexible clear plastic, for example; a fixing layer 2b composed of an adhesive agent, for example, provided on an upper surface in the drawing of the sheet base material 2a; a plurality of linear first electrodes 3 fixed by the fixing layer 2b; and an adhesive layer 2c composed of an adhesive agent provided on a rear surface in the drawing of the sheet base material 2a.

The first electrodes 3 are provided in parallel to one another and extend in a front/back direction of a paper surface of the drawing. The plurality of first electrodes 3 are covered by an electrode protection film 2d. A lower surface in the drawing of the adhesive layer 2c is covered by a sheet separator 2e that serves as a peel-off sheet. The first sheet material 2 is preferably rolled such that the first electrodes 3 are provided inside. With the first electrodes 3 provided outside, in contrast, a tensile load is exerted on the first electrodes 3, thus possibly leading to disconnection. Conversely, with the first electrodes 3 provided inside, a load in a compression direction is exerted on the first electrodes 3, thus unlikely to be disconnected.

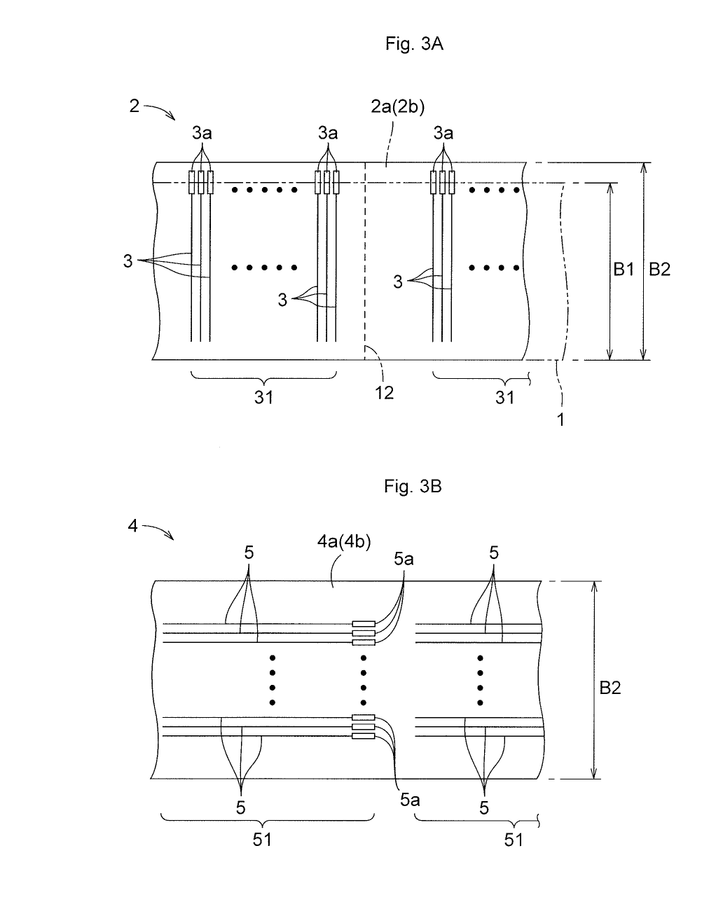

The first electrodes 3 of the first sheet material 2 extend one by one in a direction orthogonal to a feeding direction (left/right direction in the drawing) of the first sheet material 2 and are provided in parallel to one another in a plan view as shown in FIG. 3A. First electrode groups 31, each of which is composed of the first electrodes 3 in a number corresponding to a range of the size of a touch screen as a product, are continuously provided with predetermined intervals in between in the feeding direction. A first electrode lead 3a having a flat terminal shape is provided in an upper portion in the drawing of each of the first electrodes 3 for electrical connection with an external circuit (not show in the drawing).

The lower roll R3 in FIG. 1 is a rolled second sheet material 4. With reference to FIG. 2C, the second sheet material 4 has, in a laminated state, a sheet base material 4a composed of a flexible clear plastic, for example; a fixing layer 4b composed of an adhesive agent, for example, provided on an upper surface in the drawing of the sheet base material 4a; and a plurality of linear second electrodes 5 fixed by the fixing layer 4b. The plurality of second electrodes 5 extend in the left/right direction in the drawing and are provided in parallel to one another. The plurality of second electrodes 5 are covered by an electrode protection film 4c. Similar to the first sheet material 2, the second sheet material 4 is rolled such that the second electrodes 5 are provided inside.

The second electrodes 5 of the second sheet material 4 extend one by one in the feeding direction (left/right direction in the drawing) of the second sheet material 4 and are provided in parallel to one another in a plan view as shown in FIG. 3B. Second electrode groups 51, each of which is composed of the second electrodes 5 having an extending length corresponding to a range of the size of a touch screen as a product, are continuously provided with predetermined intervals in between in the feeding direction. A second electrode lead 5a having a flat terminal shape is provided in a right portion in the drawing of each of the second electrodes 5 for electrical connection with an external circuit (not show in the drawing).

The electrodes 3 and 5 are formed by etching a copper foil, for example, such that a mesh pattern including continuous rhombic meshes extends in a belt shape (not shown in the drawing). Since the electrodes are provided in such a mesh pattern, conductivity is maintained as a whole (one piece) even if a portion is disconnected.

The sheet materials 1, 2, and 4 are fed from the three rolls R1 to R3, respectively, configured as above. The sheet materials 2 and 4 are vertically laminated such that the electrode groups 31 and 51 overlap in a plan view, and then the adhesive sheet material 1 is laminated onto the first sheet material 2. Before each of the sheet is laminated, the sheet separator 1a on the first sheet material 2 side is removed from the adhesive sheet material 1, the electrode protection film 2d and the sheet separator 2e are removed from the first sheet material 2, and the electrode protection film 4c is removed from the second sheet material 4 by a peeler (not shown in the drawing). The laminated sheet materials 1, 2, and 4 are pinched between a pair of pressure rollers 6a and 6b as shown in FIG. 1, for example.

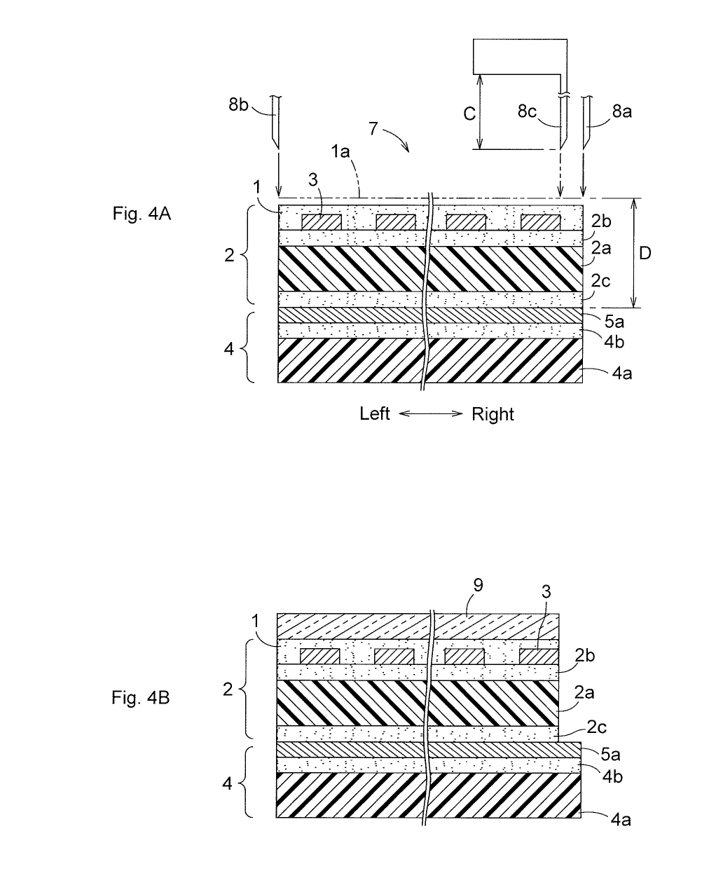

The sheet materials 1, 2, and 4 are pressed between the pair of pressure rollers 6a and 6b and are fed. Then, as shown in FIG. 4A, the adhesive sheet material 1 covering the first electrodes 3 is bonded onto the first sheet material 2, and the second sheet material 4 is bonded to the lower surface of the first sheet material 2 in a state where the second electrodes 5 are covered by the adhesive layer 2c. Thus, a laminated body of the sheet materials 1, 2, and 4 is provided as a touch screen material 7 integrated into one sheet. The touch screen material 7 is cut at a predetermined length in a feeding direction by cutters 8a and 8b disposed at predetermined intervals in the next process. The length corresponds to the length of a range in which the electrode groups 31 and 51 are disposed and may be a lateral width of a touch screen as a product, for example.

As indicated with a dashed two-dotted line in FIG. 3A, in a case where the feeding direction of the adhesive sheet material 1 is the lateral width direction of the touch screen as a product, a longitudinal width B1 orthogonal to the lateral width is shorter by a predetermined length than a longitudinal width B2 of the first sheet material 2. Aligning the ends of the adhesive sheet material 1 and the first sheet material 2 opposite to the first electrode lead 3 side as shown in FIG. 4A for lamination allows exposure of a portion of the first electrode lead 3a at the end of the first electrode 3.

Subsequently, the touch screen material 7 is cut by a cutter 8c at a position for a predetermined length to the left from the right end in FIG. 4A for a depth where the second electrodes 5 are exposed. Then, the right end portions of the adhesive sheet material 1 and the first sheet material 2 are cut off. The cutter 8c preferably has an L shape, as shown in the drawing, composed of a main portion and a blade for cutting, the main portion being pressed against the front surface of the sheet separator 1a, for example. In this case, a length (cutting depth) C of the blade of the cutter 8c is slightly shorter than a length D from the front surface of the sheet separator 1a to the second electrode lead 5a (C<D). It is preferred that the blade edge be set so as not to reach the second electrode lead 5a even if the adhesive sheet material 1 and the fixing layer 2b are elastically deformed due to the pressing force of the main body of the cutter 8c. Thus, as shown in FIG. 4B, the adhesive sheet material 1 and the first sheet material 2 are cut off for a predetermined length L from the right end in the drawing of the second sheet material 3 and a portion of the second electrode lead 5a at the end of the second electrode 5 is exposed.

As a guide to position the cutter 8c, guiding perforations 12 may be provided, for example, as shown in FIG. 3A. This allows easy and highly accurate positioning for cutting in a cutting process by the cutter 8c.

As described above, the sheet materials 1, 2, and 4 are fed from the rolled rolls R1 to R3, respectively, and are laminated and bonded. With the adhesive agent previously integrated to either of the first sheet material 2 or the second sheet material 4 (first sheet material 2 in the embodiment), pressing the laminated sheet materials 1, 2, and 4 fed from the rolls R1 to R3, respectively, by the pair of press rollers 6a and 6b readily bonds the sheet materials 1, 2, and 4. This simplifies a bonding process in which sheet materials are laminated sheet by sheet in order and each of the sheet materials is positioned for bonding. In addition, pressing by the pair of press rollers 6a and 6b for bonding prevents bubbles from forming between the bonded surfaces, thus improving the yield and reducing the production cost.

Thus, the sheet materials 1, 2, and 4 are bonded in a laminated state and thereby the touch screen material 7 is provided that functions as a capacitance touch screen in which the electrodes 3 and 5 are provided opposite to each other with predetermined distances such that a plurality of intersections are provided in a plan view. The electrode leads 3a and 5a are exposed as described above.

After the touch screen material 7 is provided, a sheet glass 9 is placed and bonded to the adhesive sheet material 1 as shown in FIG. 4B. The sheet glass 9 is prepared in advance in the size of a touch screen as a product. In the case of bonding the sheet glass 9, the sheet glass 9 is bonded later as described above. In a case of a touch screen to which a flexible clear material is bonded instead of the sheet glass 9, the clear material may be inserted concurrently in the pinching process of the sheet materials 1, 2, and 4 between the pair of the press rollers 6a and 6b, thus further streamlining the process.

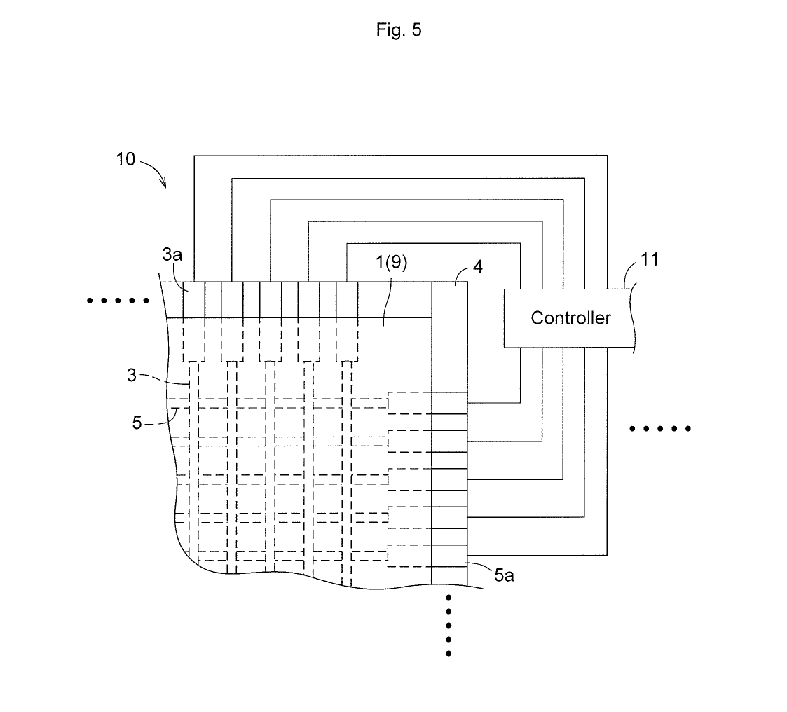

With reference to FIG. 5, which schematically illustrates an enlarged portion of the touch screen 10 produced in the process above, the first electrode leads 3a are disposed in parallel on one side and the second electrode leads 5a are disposed in parallel on another side having one corner of a rectangle therebetween. The electrode leads 3a and 5a are electrically connected to an external controller 11 through lead wires.

In the laminated structure of the embodiment above, the first electrodes 3 are provided on the upper side and the second electrodes 5 are provided on the lower side. The laminated structure, however, is not limited to above. A laminated structure may have the first electrodes 3 on the lower side and the second electrodes 5 on the upper side. In this case, a portion in which the first electrode leads 3a are covered by the second sheet material 4 may be cut off in a similar manner to the cutting by the cutter 8c.

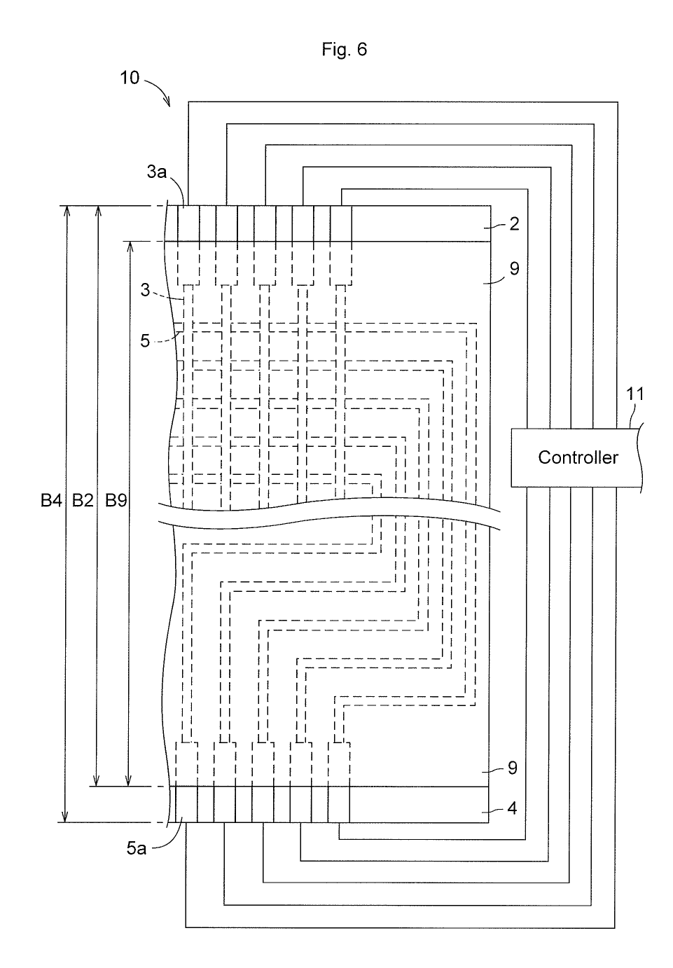

The electrode leads 3a and 5a are disposed such that they are arranged along two sides with one corner of the rectangular touch screen 1 therebetween. Alternatively, the electrodes may be disposed along opposing sides, as shown in FIG. 6, for example, as a second embodiment. In FIG. 6, the first sheet material 2 is laminated onto the second sheet material 4, and the sheet glass 9 is laminated onto the first sheet material 2, similar to the embodiment above. The first electrode leads 3a are disposed in parallel along the upper side in the drawing, similar to the embodiment above, while the second electrode leads 5a are disposed in parallel along the lower side in the drawing, opposite to the side along which the first electrode leads 3a are disposed.

As shown in FIG. 6, longitudinal widths B2, B4, and B9 of the sheet materials 2 and 4 and the sheet glass 9, respectively, are defined such that the longitudinal width B2 of the first sheet material 2 laminated onto the second sheet material 4 is shorter than the longitudinal width B4 of the second sheet material 4 to expose portions of the second electrode leads 5a and such that the longitudinal width B9 of the sheet glass 9 is shorter than the longitudinal width B2 of the first sheet material 2 to expose portions of the first electrode leads 3a. The adhesive sheet material 1 has the same longitudinal width as the sheet glass 9. Thus, the electrode leads 3a and 5a are exposed in a state in which the sheet materials 2 and 4 and the sheet glass 9 are laminated, eliminating the process to partially cut by the cutter 8c in the embodiment above.

Eliminating the cutting process in the second embodiment facilitates cost reduction. However, a transmission path to the second electrode lead 5a of the second electrode 5 is longer than that in the first embodiment as shown in FIG. 6. Thus, the layout may be appropriately selected according to a purpose of use. Specifically, in a case where high transmission efficiency is required, short transmission paths to the electrode leads 3a and 5a of the electrodes 3 and 5, respectively, are prioritized as shown in FIG. 5, while in the case where it is unnecessary to consider an impact of reduced transmission efficiency, the second embodiment is employed.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A method of producing a touch screen comprising:
a first sheet material having a plurality of linear first electrodes disposed in parallel to one another;
a second sheet material having a plurality of linear second electrodes disposed in parallel to one another; and
a laminated body provided by bonding the first sheet material onto the second sheet material such that the first electrodes and the second electrodes intersect with each other, the method comprising:
rolling the first sheet material and the second sheet material in directions in which the first electrodes and the second electrodes intersect with each other;
providing an adhesive layer and a peel-off sheet covering the adhesive layer on at least one of the first sheet material and the second sheet material;
feeding the rolled first sheet material and the rolled second sheet material;
removing the peel-off sheet; and
bonding the first sheet material and the second sheet material with the adhesive layer therebetween to form the laminated body.

2. The method of producing the touch screen according to claim 1, wherein
a second electrode lead is provided at an end portion of the second electrode for connection with an external circuit, and
a mark for cutting off a portion covering the second electrode lead is provided on the first sheet material to expose the second electrode lead from the laminated body.

3. The method of producing the touch screen according to claim 1, wherein surface roughness of a surface in contact with the adhesive layer of the peel-off sheet is greater than that of a surface on which the adhesive layer of the sheet material is provided.

4. The method of producing the touch screen according to claim 1, wherein a sheet glass is bonded after the laminated body is formed.

5. A method of producing a touch screen, comprising:
rolling a first sheet material having a plurality of linear first electrodes disposed in parallel to one another;
rolling a second sheet material having a plurality of linear second electrodes disposed in parallel to one another;
feeding the rolled first sheet material and the rolled second sheet material; and
bonding the first sheet material and the second sheet material to form a laminated body.

6. A touch screen comprising:
a first sheet material having a plurality of linear first electrodes disposed in parallel to one another;
a second sheet material having a plurality of linear second electrodes disposed in parallel to one another; and
a laminated body provided by bonding the first sheet material onto the second sheet material such that the first electrodes and the second electrodes intersect with each other, wherein
the first sheet material and the second sheet material are rolled in directions in which the first electrodes and the second electrodes intersect with each other,
an adhesive layer and a peel-off sheet covering the adhesive layer are provided on at least one of the first sheet material and the second sheet material,
the rolled first sheet material and the rolled second sheet material are fed,
the peel-off sheet is removed, and
the first sheet material and the second sheet material are bonded with the adhesive layer therebetween to form the laminated body.

7. The touch screen according to claim 6, wherein
a second electrode lead is provided at an end portion of the second electrode for connection with an external circuit, and
a mark for cutting off a portion covering the second electrode lead is provided on the first sheet material to expose the second electrode lead from the laminated body.

8. The touch screen according to claim 6, wherein surface roughness of a surface in contact with the adhesive layer of the peel-off sheet is greater than that of a surface on which the adhesive layer of the sheet material is provided.

9. The touch screen according to claim 6, wherein a sheet glass is bonded after the laminated body is formed.

10. A white board comprising the touch screen according to claim 6.
